(19) United States
(12) Patent Application Publication
(10) Pub. No.: US 2013/0125022 A1
(43) Pub. Date: May 16, 2013

(54) METHOD, DEVICE AND SYSTEM FOR SENDING, RECEIVING AND UPDATING INTERACTIVE INFORMATION ON THE INTERNET

(71) Applicant: Shixiong Cao, Shenzhen City (CN)

(72) Inventor: Shixiong Cao, Shenzhen City (CN)

(73) Assignee: TENCENT TECHNOLOGY (SHENZHEN) COMPANY LIMITED, Shenzhen City (CN)

(21) Appl. No.: 13/734,528

(22) Filed: Jan. 4, 2013

Related U.S. Application Data
(63) Continuation of application No. PCT/CN2011/077535, filed on Jul. 25, 2011.

(30) Foreign Application Priority Data
Aug. 16, 2010 (CN) 201010255523.2

(51) Int. Cl. H04L 12/58

(52) U.S. Cl. CPC H04L 51/00
USPC 715/752

(57) ABSTRACT

Method, device and system for receiving, sending and updating interactive information on the Internet are disclosed. A method includes: after detecting a predetermined type of a user's operation, a user device prompts the user to input a contact address of a recipient of the interactive information; the user device then sends, to the contact address of the recipient, electronic information including content of the interactive information and a URL address with a passcode of the recipient. Another method includes: a user device receives and displays electronic information sent to a contact address of a user, the electronic information includes content of the interactive information and a URL address with a passcode of the user; and after detecting a click on the URL address, the user device sends a response from the contact address of the user to a server, content of the response includes the passcode of the user.

CROSS-REFERENCE TO RELATED PATENT APPLICATIONS

This application is a continuation application of an International Application No. PCT/CN2011/077535, filed Jul. 25, 2011, entitled “INTERACTION METHOD, DEVICE AND SYSTEM FOR INTERACTIVE MESSAGE ON INTERNET,” by Shixiong CAO, which claims the priority from the Chinese patent application No. CN201010255523.2, filed Aug. 16, 2010, entitled “INTERACTION METHOD, DEVICE AND SYSTEM FOR INTERACTIVE MESSAGE ON INTERNET”, by Shixiong CAO, the disclosures of which are hereby incorporated herein in their entireties by reference.

### FIELD OF THE INVENTION

The present invention relates generally to the field of Internet technology, and more particularly to a method, device and system for sending, receiving and updating interactive information on the Internet.

### BACKGROUND OF THE INVENTION

With the development of the Internet technology, more and more users communicate with each other via the Internet. The existing interaction method for interactive information on the Internet is that exchanging of interactive information is performed within an interface corresponding to the interactive information after a user enters into the interface. The interactive information may be a vote, a log, or an album, etc.

However, the prior art has the following problems.

The users have to enter the interface corresponding to the interactive information when the users exchange the interactive information. Accordingly, the participants of interaction are limited to registered users in the website related to the interactive information.

Therefore, heretofore unaddressed needs exist in the art to address the aforementioned deficiencies and inadequacies.

### SUMMARY OF THE INVENTION

It is an object of the present invention to provide methods and systems for sending, receiving and updating interactive information on the Internet.

According to an aspect of the invention, a method for sending interactive information from a user device on the Internet includes the following steps: After detecting a predetermined type of operation by a user at a user device, the user is prompted to input a contact address of a recipient of the interactive information. Then, electronic information is sent by the user device to the contact address of the recipient, where the electronic information includes the interactive information and a uniform resource locator (URL) address that contains a passcode as a unique identifier of the recipient.

According to another further aspect of the invention, a method for receiving interactive information on the Internet includes the steps of receiving, at a user device, electronic information sent to a contact address of a user and displaying at the user device the received electronic information, the received electronic information comprising content of the interactive information and a URL address that contains a passcode as a unique identifier of the user; and sending, by the user device after detecting a click on the URL address, a response of the interactive information from the contact address of the user to a server, content of the response of the interactive information including the passcode of the user.

According to yet another aspect of the invention, a method for updating interactive information on the Internet includes the following steps: (a) prompting, by a first user device, a first user to input a contact address of a second user, after detecting a predetermined type of operation by the first user; (b) sending, by the first user device, electronic information to the contact address of the second user, the electronic information containing certain interactive information and a URL address that contains a passcode as a unique identifier of the second user; (c) receiving, at a second user device, the electronic information and displaying at the second user device the received electronic information; (d) sending, by the second user device and after detecting a click on the URL, a response of the interactive information from the contact address of the second user to a server, content of the response of the interactive information containing the passcode of the second user; and (e) updating, by the server, the interactive information posted on a web site according to the response received.

According to a further aspect of the invention, a user device for sending interactive information on the Internet has a prompting unit, configured to prompt a user to input a contact address of a recipient of the interactive information after detecting a predetermined type of operation by the user; and a transmission unit, configured to send electronic information to the contact address of the recipient, the electronic information containing the interactive information and a URL address that contains a passcode as a unique identifier of the recipient.

According to a further aspect of the invention, a user device for receiving interactive information on the Internet includes a display unit, configured to receive and display electronic information sent to a contact address of a user, the electronic information containing content of the interactive information and a URL address having a passcode as a unique identifier of the user; and a transmission unit, configured to send, after detecting a click on the URL address, a response of the interactive information from the contact address of the user to a server, content of the response of the interactive information having the passcode of the user.

According to still a further aspect of the invention, a system for updating interactive information on the Internet comprises a first user device, configured to prompt a first user to input a contact address of a second user, after detecting a predetermined type of operation by the first user; and to send electronic information to the contact address of the second user, the electronic information containing the interactive information and an URL address having a passcode as a unique identifier of the second user; a second user device, configured to receive and display the electronic information; and to send, after detecting a click on the URL address, a response of the interactive information from the contact address of the second user to a server, content of the response of the interactive information having the passcode of the second user; and a server, configured to update the interactive information posted on a web site according to the response received.

Comparing with the prior art, the present invention has the following advantages: in the present invention, the electronic information is sent to the contact address of the participant to exchange the interactive information, thus the participants of interaction are not limited to registered users in the website related to the interactive information. Accordingly, the invention has less limitation on the participants of interactive information and increases the interactive modes of the interactive information.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a flowchart of a method for sending interactive information on the Internet according to one embodiment of the present invention.

FIG. 2 is a flowchart of a method of sending interactive information on the Internet according to one embodiment of the present invention.

FIG. 3 is an exemplary diagram of specific content of an email received according to one embodiment of the present invention.

FIG. 4 is a flowchart of a method for participating interactive information on the Internet according to one embodiment of the present invention.

FIG. 5 is a flowchart of a method for updating interactive information according to one embodiment of the present invention.

FIG. 6 is a flowchart of a method for updating interactive information according to one embodiment of the present invention.

FIG. 7 is a structural diagram of a device for sending interactive information according to one embodiment of the present invention.

FIG. 8 is a structural diagram of a device for participating interactive information according to one embodiment of the present invention.

FIG. 9 is a structural diagram of a system for updating interactive information according to one embodiment of the present invention.

FIG. 10 is a flowchart of a method for updating interactive information according to one embodiment of the present invention.

FIG. 11 illustrates a scenario of voting through an email according to one embodiment of the present invention.

FIG. 12 illustrates a scenario of a successful voting according to one embodiment of the present invention.

### DETAILED DESCRIPTION OF THE PREFERRED EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

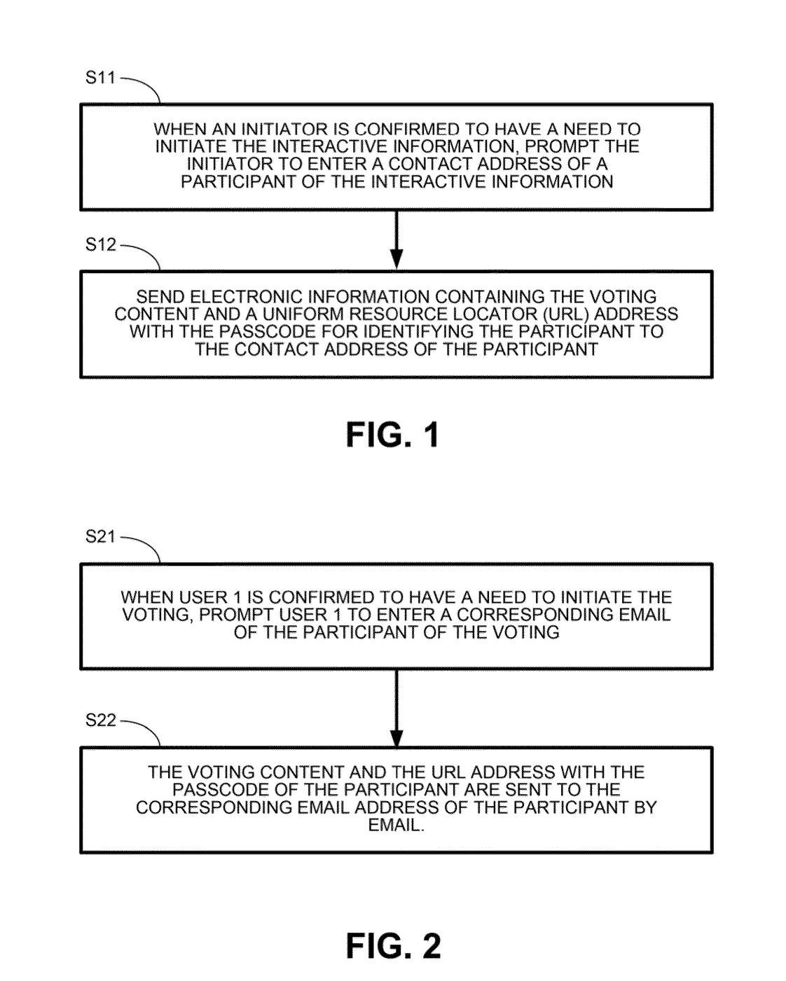

An interaction method for interactive information on the Internet is implemented by an initiator device which may be a computer, a mobile terminal, or a PDA, etc. As shown in FIG. 1, the interaction method may include the following steps.

S11: the initiator device prompts an initiator to input a contact address of a participant of interactive information, when the initiator is confirmed to have a need for initiation of the interactive information;

The contact address may be an email address. However, the contact address may also be a mobile phone number or other address that may receive the interactive information.

S12: the initiator device sends to the contact address of the participant electronic information containing content of the interactive information and a URL address that contains a passcode for identifying the participant.

The electronic information may be an email when the contact address is an email address, and the electronic information may also be a text message or a multimedia message when the contact address is a mobile phone number.

It should be emphasized that the passcode may be identification in the form of a password. The identification is for identifying the participant, and its specific form may be a URL address.

It should be emphasized that the URL address may be a URL address automatically generated when the initiator device sends the electronic information, and the URL address is inserted into the electronic information which is then transmitted.

It should be emphasized that the method above after S11 may further include a step: displaying contact addresses of contact persons of the initiator.

The interactive information can be: voting, log, album, etc.

According to the method disclosed in the present embodiment, a voting is completed by sending electronic information to the contact addresses of contact persons of the initiator. Since the method has no specific limits on the contact addresses of the contact persons, therefore when the method completes the interaction, the participants do not have to be registered users of a website hosting the voting. The method thus expands the scope of participants and is characterized by the expanded voting scope.

### Embodiment 1

A method of sending the interactive information on the Internet is provided in the present embodiment, and the technical environment that the present embodiment can be implemented is: the method provided in the present embodiment is completed by a computer, a mobile terminal, or a Personal Digital Assistant (PDA), as long as the device can access the internet. In the present embodiment, interactive information is, for example, voting information, and the contact address is, for example an email address. The interactive information may be other type of information, for example a log or an album. In one exemplary scenario, User 1 is a voting initiator. User 1 imitates the voting through a website (e.g., a social networking service website such as Qzone, or other social networking service website like Facebook, or blogging sites like Wordpress, Blogger, etc., or any other websites where voting may be hosted) with the emails of participants of the voting: the corresponding email of participant A is: 123@139.com; the corresponding email of participant B is: 456@MSN.com; the method provided in the present embodiment is shown in FIG. 2, and includes the flowing steps.

In S21, when confirmed to have a need for initiation of a voting, an initiator device prompts User 1 to enter a corresponding email of a participant of the voting.

The following example may be used to show how S21 may be implemented. After the initiator device detects that User 1 has entered the interface of Qzone voting section, and receives the voting information that is initiated or edited by User 1, the initiator device then may be able to confirm that User 1 has a need for initiating a voting. The initiator device then displays the interface for entering emails to User 1. When the interface for entering email addresses are displayed to User 1, the names and email addresses of contact persons of User 1 may be displayed. In one embodiment, the names and email addresses of contact persons of User 1 can be displayed in an email entering interface, and in another embodiment, the names and email addresses of contact persons of User 1 can be created as another interface (a contact person interface), which may be displayed by the side of the email entering interface. Other forms of interface generating and displaying can also be applied, the present invention is not limited by the examples of the names and email addresses of contact persons.

In S22, the initiator device sends the voting content and the Universal Resource Locator (URL) address that contains the participant's passcode to the corresponding email addresses of the participant by email.

S21 may be implemented as following. After the initiator device receives the email addresses of Participant A and Participant B entered by User 1, the initiator device sends the voting content to 123@139.com by email; the email contains the URL address with the passcode that identifies Participant A. Meanwhile, the initiator device also sends the voting content to 456@MSN.com by email; the email also contains the URL address with another passcode that identifies Participant B.

It should be emphasized that the contact addresses can be mobile phone numbers of the contact persons, when the contact address is a mobile phone number, the above method may be modified by altering the email address into the mobile phone number in the embodiment S21, altering the email address into text messages or multimedia messages of mobile phone in S22, and replacing the email with the mobile phone number in S22.

When the method provided in the present embodiment is used in participating the voting interaction, Participant A and participant B are not required to be registered users of the website that hosts the voting event. Participant A and participant B are only required to have their own contact information, in this example, their corresponding email addresses. In the above example Participant A and Participant B of the present embodiment are not the registered users of the website which hosts the voting (Participant A is a user of 139, while Participant B is a user of MSN, and both of them are not Qzone users); thus, the method expands the scope of participants and is characterized by the expanded voting scope.

### Embodiment 2

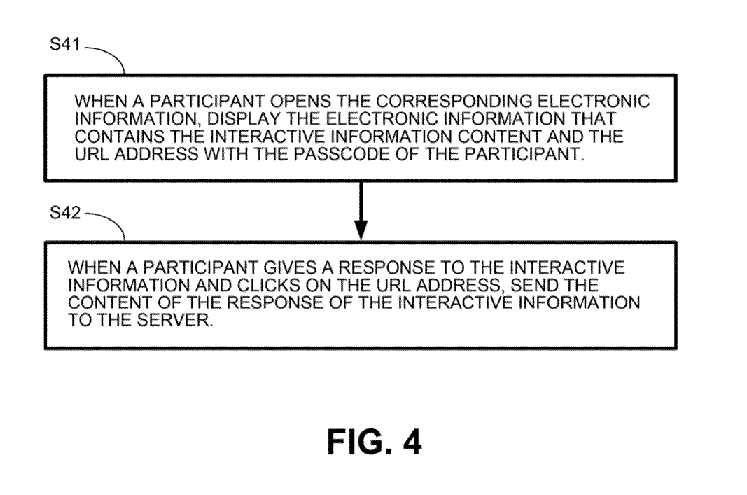

A method of receiving and participating interactive information on the Internet is provided in the present embodiment, and the technical environment that the present embodiment can be implemented is: the method provided in the present embodiment is completed by an operation device of a participant, which can be a computer, a mobile terminal, a PDA, etc. The method provided in the present embodiment as shown in FIG. 4 includes the flowing steps.

In S41, when the participant opens the corresponding electronic information, the operation device displays the electronic information to the participant; the electronic information contains content of the interactive information and the URL address that contains the passcode for identifying the participant.

In S42, when the participant gives a response to the interactive information and clicks on the URL address, content of the response to the interactive information is sent by the operation device to the server.

It should be emphasized that after the participant's clicking on the URL address and the response content of the interactive information being sent to the server, an interface showing the successful voting of the participant may be displayed, and voting results may also be displayed. An example of the successful voting interface including the voting results is displayed in FIG. 12.

Examples of the forms and the types of the electronic information can be referred to the corresponding description for S12.

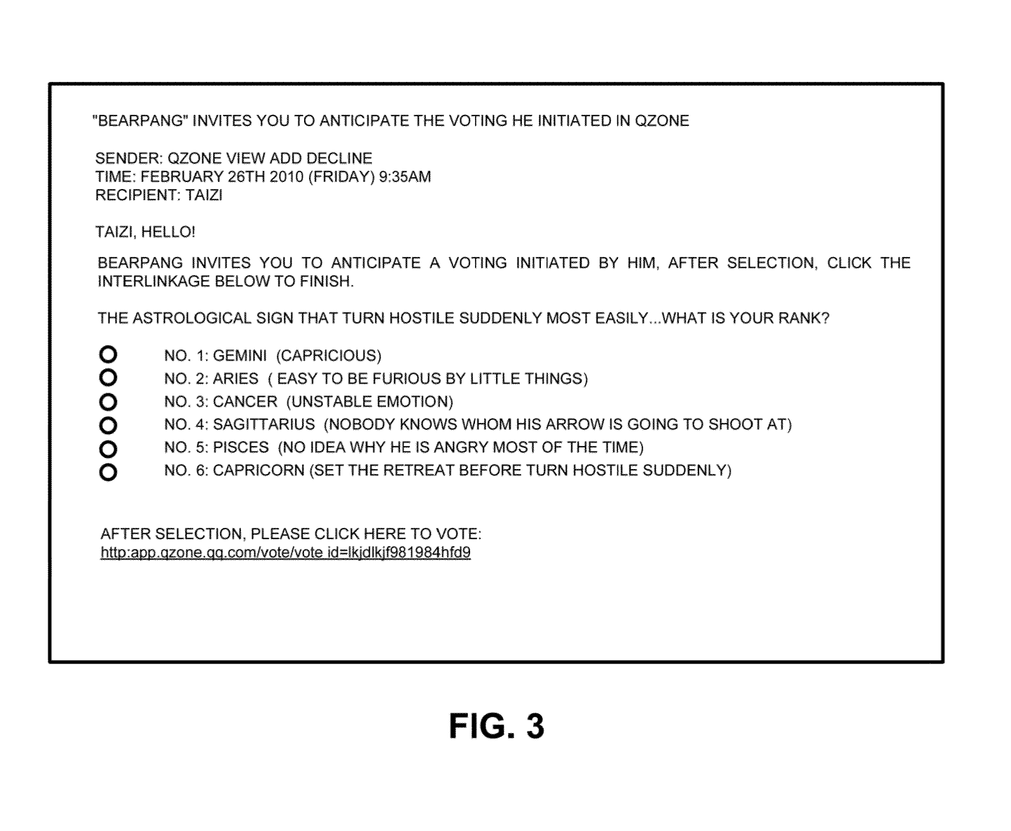

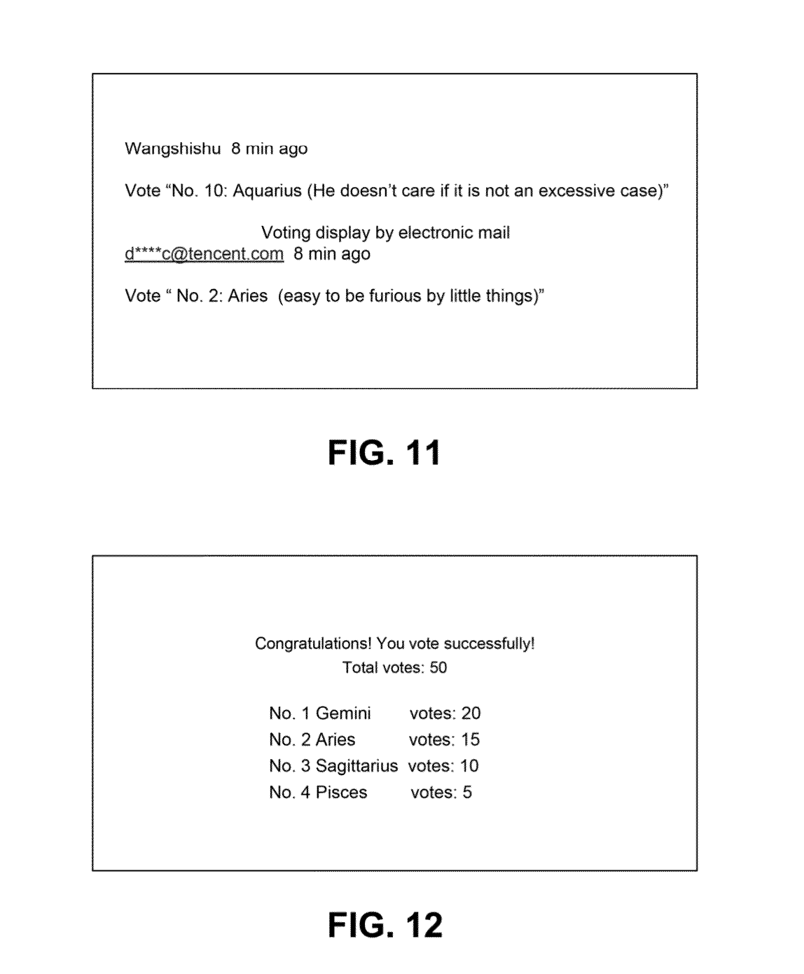

It should be noted that the detail content of the received email can be shown as the example email in FIG. 3. The link shown in FIG. 3 is the URL address. When the participant gives a response to the voting and clicks on the URL address with the passcode that identifies the participant, the passcode of the participant is sent back to Server. After receiving the passcode of the participant, the server updates the voting information according to the content of the response and the passcode of the participant. For example, an exemplary image of voting by email is as shown in FIG. 11.

It should be noted that according to the different forms of the interactive information, the content of the response may be different. For example, when the interactive information is voting, the content of the response to the interactive information can be a selected voting item. When the interactive information is an album, the content of the response to the interactive information can be comments to the album. When the interactive information is a log, the content of the response to the interactive information can be a reply to the log.

The method provided in the present embodiment receives the electronic information which contains the interactive information and the URL, displays the electronic information after the participant opens the electronic information, and sends the responsive content to the server when the participant give a response to the interactive information and clicks on the URL address, and the server updates the voting information and completes the voting process after receiving the content of the response.

### Embodiment 3

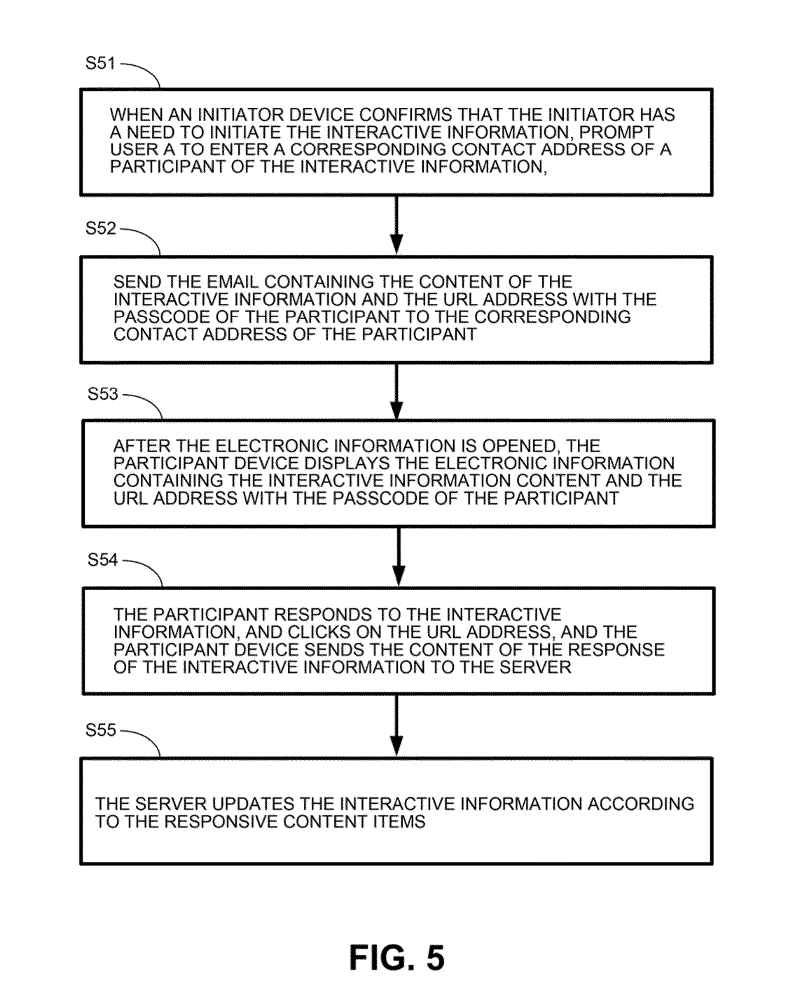

A method for updating interactive information is provided in the present embodiment. The method as shown in FIG. 5 includes the flowing steps.

In S51, when an initiator device confirms that an initiator has a need for initiation of the interactive information, it prompts User A to input a corresponding contact address of a participant of the interactive information.

In S52, the initiator device sends electronic information containing content of the interactive information and the URL address with the passcode for identifying the participant to the corresponding contact address of the participant.

In S53, after the electronic information is opened, the participant device displays the electronic information containing the content of the interactive information and the URL address with the passcode of the participant.

In S54, after the participant gives a response to the interactive information and clicks on the URL address, the participant device sends content of the response to the server.

In S55, the server updates the interactive information according to the content of the response.

In one embodiment, after the participant gives a response to the interactive information content and clicks on the URL address with the passcode of the participant, the participant device further sends the passcode of the participant back to the server. The server receives the passcode of the participant, and updates the interactive information according to the passcode of the participant and the content of the response received.

It should be noted that the contact address above can be email address or mobile phone number. When the address of the contact person is an email address, the electronic information can be an email. When contact address is a mobile phone number, the electronic information can be a text message or a multimedia message.

It should be noted that according to different forms of interactive information, the content of the response to the interactive information content may be different. For example, when the interactive information is voting, the content of the response may be a selected voting item. When the interactive information is an album, the content of the response can be comments to the album. When the interactive information is a log, the interactive information content can be a reply to the log.

The method disclosed in the present embodiment performs the interaction in the form of electronic information. Thus, when the interactive information exchanging is performed according to the disclosed method, the participants are not required to be users of the website which hosts the voting. Accordingly, the method is characterized in that it expands the voting scope by expanding the scope of the participants.

### Embodiment 4

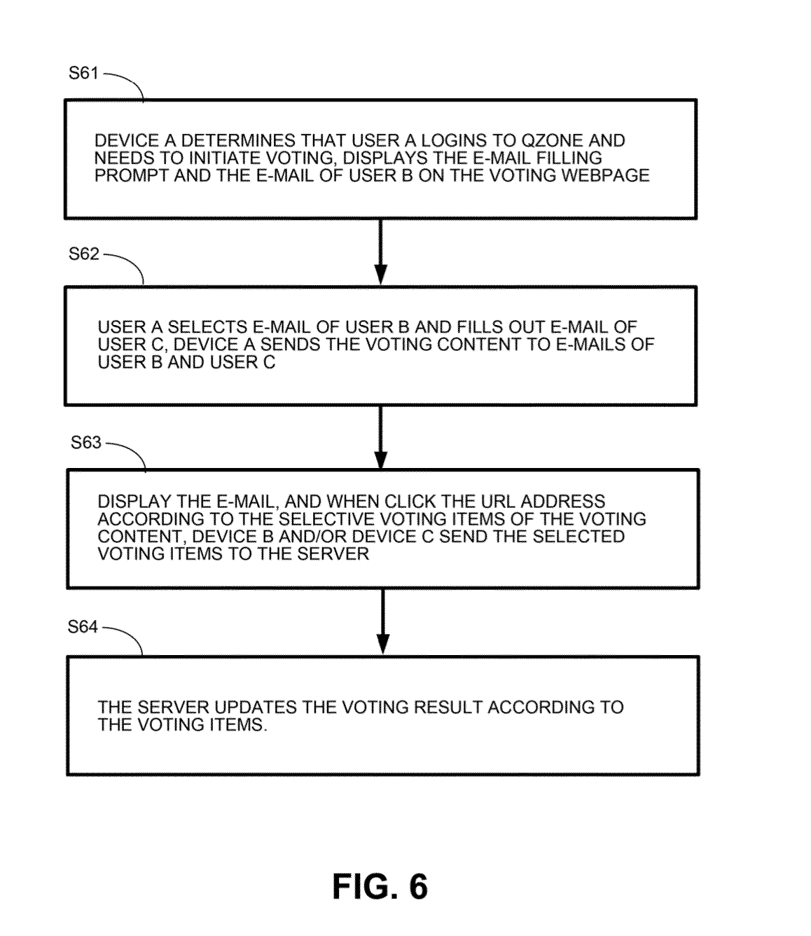

A method of updating the interactive information is provided in the present embodiment. An exemplary scenario according to the present embodiment is explained with the example of voting by User A, User B and User C. User A is assumed as a user of the social networking website Qzone and also as a user of an instant messenger associated with the Qzone (QQ), User B is a contact person of User A that can be contacted through the instant messenger QQ, and User C is not a contact person of User A. In this scenario, the electronic devices used by User A, B, C are Device A, Device B, and Device C, respectively. The electronic device used in this method may be a computer, a mobile phone, a PDA etc. The method shown in FIG. 6 includes the following steps.

In S61, Device A confirms that User A logs into Qzone and needs to initiate voting, then on the voting webpage, it displays a prompt to fill out an invitation e-mail to the voting, and it also displays the e-mail of User B.

In S62, User A selects the e-mail of User B and fills out an e-mail of User C, Device A then sends the voting content to the e-mail addresses of User B and User C.

It should be emphasized that the e-mail described above further includes the URL address with the passcode of the participant. When the participant is User B, it includes the URL address with the passcode of User B. When the participant is User C, it includes the URL address with the passcode of User C. The URL address with the passcode is applied to uniquely recognize the user when the user clicks on it. For example, when User C clicks on the URL address with the passcode of the received email, it uniquely recognizes User C.

In S63, Device B and/or Device C display the e-mail when User B and User C open their respective e-mails, and when User B and/or User C click on the URL address after having made their respective selections among the voting items of the voting content, Device B and/or Device C send the selected voting items to the server.

In S64, the server updates the voting result according to the received voting items.

The method disclosed in the present embodiment carries out the voting interaction by email. Thus, the participants are not required to be users of the website which hosts the voting. Accordingly, the method is characterized in that it expands the scope of participants and therefore expands voting scope.

### Embodiment 5

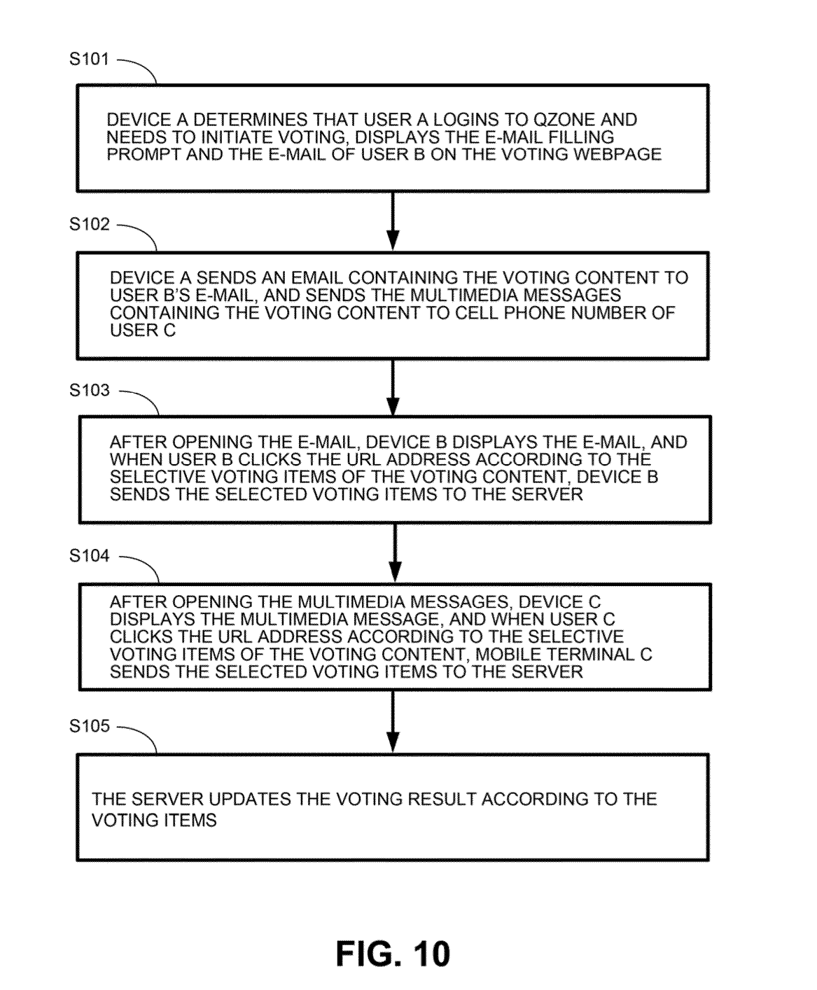

A method of updating the interactive information is provided in the present embodiment, and an exemplary scenario according to the present embodiment is explained with the example of voting by User A, User B and User C. User A is assumed as a user of the social networking website Qzone and of the instant messenger associated with the Qzone (QQ), User B is a QQ contact person of User A, and the contact address of User B is an email address. User C is not a contact person of User A, and the contact address of User C is a mobile phone number, wherein electronic devices used by User A, B, C are Device A, Device B, and Device C, respectively. The electronic device used in this method may be a computer, a mobile phone, a PDA etc. A multimedia message sent to User C is used as an example in the present embodiment, or in a real world situation, the multimedia message may be a text message. The method shown in FIG. 10 includes the following steps.

In S101, Device A confirms that User A logs into Qzone and needs to initiate voting, then it displays an e-mail filling prompt and the e-mail address of User B on the voting webpage.

In S101, User A selects the e-mail of User B and fills out the mobile phone number of User C, Device A then sends the email containing the voting content to the e-mail address of User B, and sends the multimedia message containing the voting content to the mobile phone number User C.

It should be noted that the e-mail described above further includes the URL address with the passcode of the User B. The multimedia message contains the URL address with the passcode of the User C.

In S103, Device B displays the e-mail when User B opens the e-mail, and when User B clicks on the URL address after having made selection(s) among the voting items of the voting content, Device B sends the selected voting items to the server.

In S104, Device C displays the multimedia message when User C opens the multimedia messages, and when User C clicks on the URL address after having made selection(s) among the voting items of the voting content, Mobile Terminal C sends the selected voting items to the server.

In S105, the server updates the voting result according to the receiving voting items.

The method disclosed in the present embodiment carries out the voting interaction by email and multimedia message, so the participants are not required to be the users of the website which hosts the voting event. Accordingly, the method expands the scope of participants and the voting scope as well.

It should be noted that during the execution order of S103 and S104 does not need to be performed in the specific order as described above, instead, these steps may be performed in a random order, i.e., S103 can be executed after S104, or can be executed at the same time with S104.

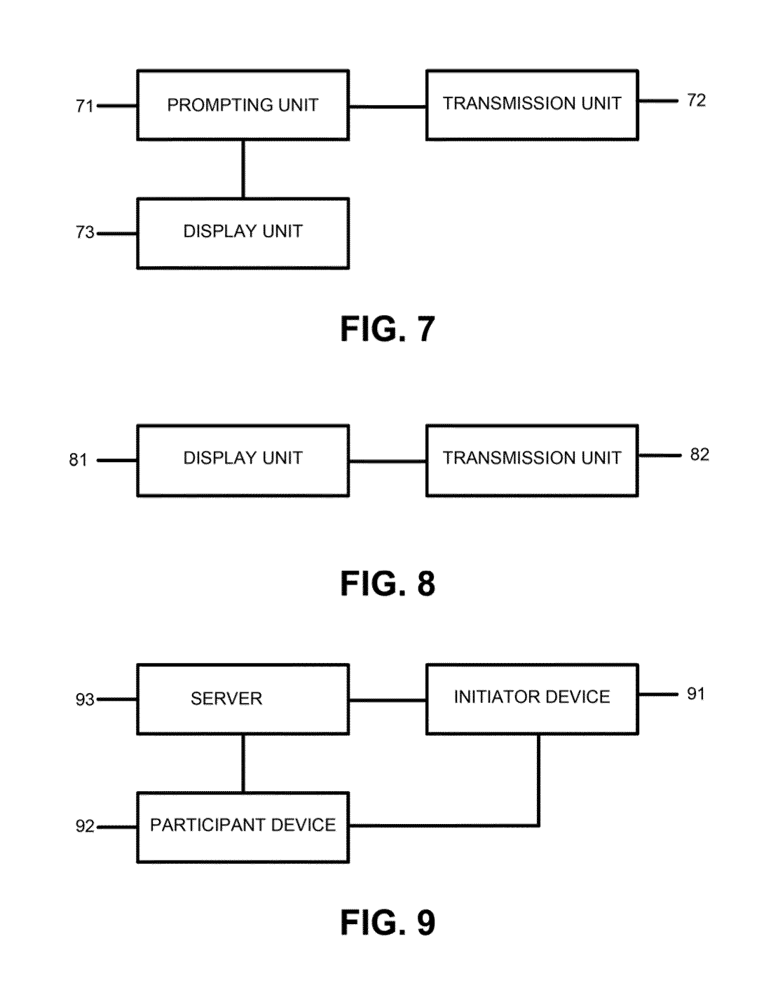

The present invention further provides an interaction device for communicating interactive information on the Internet, which can be set alone or set inside of a computer, a mobile terminal or a PDA. The interaction device, as shown in FIG. 7, includes the following components.

An interactive device may include a prompting unit 71 that is configured such that when a user initiator is confirmed to have a need for initiation of interactive information, the user initiator is prompted to enter a contact address of a participant of the interactive information.

The interactive device may also include a transmission unit 72, which is configured to send electronic information containing the content of the interactive information and a URL address with a passcode of the participant to the participant's contact address.

Optionally, the above device may further include a display unit 73, which is configured to display contact addresses of contact persons of the user initiator.

The above contact address and the electronic information may take the forms described in the previous method embodiments.

The interactive device for interactive information on the Internet disclosed in the present embodiment carries out sending interactive information by electronic information. Thus, the participants are not required to be users of the website which holds the voting event. Accordingly, the method expands the scope of participants as well as the voting scope.

The present invention further provides a participation device for interactive information on the Internet, which can be set alone or set inside of computer, mobile terminal or PDA. As shown in FIG. 8, the device includes the following components.

The participation device may include a display unit 81 that is configured to display electronic information containing the content of the interactive information and a URL address containing a passcode of the participant, after a user participant opens the electronic information.

The participation device may also include a transmission unit 82 that is configured such that, after the participant gives a response to the interactive information and clicks on the URL address, the content of the response of the interactive information is sent to the server.

The transmission unit 82 may be further configured to send the passcode of the participant to the server, after the participant gives a response to the interactive information and clicks on the URL address that contains the passcode of the participant.

The participation device for interactive information on the Internet disclosed in the present embodiment carries out the interactive information exchanging by electronic information. Thus, the participants are not required to be the users of the website which holds the voting event. Accordingly, the method expands the scope of participants and the voting scope.

The present invention further provides a system for updating interactive information on the Internet. As shown in FIG. 9, the system includes an initiator device 91, a participant device 92 and a server 93.

The initiator device 91 prompts a user initiator to input a contact address of a participant of the interactive information, and when the user initiator is confirmed to have a need for initiation of interactive information, sends electronic information containing the content of the interactive information and a URL address containing the passcode of the participant to the contact address of the participant.

After the participant opens the electronic information, the participant device 92 displays the electronic information containing the content of the interactive information and the URL address containing the passcode of the participant. After the participant gives a response to the interactive information and clicks on the URL address, the participant device 92 sends the content of the response of the interactive information to the server;

The server 93 updates the interactive information according to the content of the response received.

In one embodiment, the participant device 92 sends the passcode of the participant to the server 93 after the participant gives a response to the interactive information and clicks on the URL address of the URL containing the passcode of the participant. The server 93 updates the interactive information according to the passcode of the participant and the content of the response received.

The system provided in the present embodiment implements the interactive information exchanging through electronic information. Thus, the participants are not required to be the users of the website which holds the voting event. Accordingly, the method expands the scope of participants and the voting scope.

It should be noted that in the above embodiments of the system, the units are divided according to their logic functions. However, the above division is not limiting, other divisions can also be implemented as long as the corresponding functions can be achieved. Furthermore, the names of the functional units are only used to facilitate distinguishing these units and not intended to limit the scope of the invention.

In addition, it will be appreciated by those skilled in the art that the complete or a part of the steps of the methods in the above embodiments can be achieved by programs to instruct the relevant hardware. The relevant programs can be stored in a computer readable storage medium. The abovementioned storage medium can be a read only memory, magnetic disk or CD-ROM, etc.

In conclusion, the technical solutions of this invention expand the scope of the participants.

It should be emphasized that the above-described embodiments of the present invention, particularly, any “preferred” embodiments, are merely possible examples of implementations. Many variations and modifications may be made to the above-described embodiment(s) of the invention without departing substantially from the spirit and principles of the invention. All such modifications and variations are intended to be included herein within the scope of this disclosure.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for sending interactive information from a user device on the Internet, comprising:
prompting, after detecting a predetermined type of operation by a user at the user device, the user to input a contact address of a recipient of the interactive information; and
sending electronic information by the user device to the contact address of the recipient, the electronic information comprising the interactive information and a uniform resource locator (URL) address that contains a passcode as a unique identifier of the recipient.

2. The method of claim 1, wherein the interactive information comprises at least one of voting information, log information and album information.

3. The method of claim 1, wherein the predetermined type of operation comprises at least one of initiating the interactive information, editing the interactive information, and entering a web page associated with the interactive information.

4. The method of claim 1, further comprising: displaying, by the user device, contact addresses of contact persons of the user when prompting the user to input the contact address of the recipient.

5. The method of claim 1, wherein sending the electronic information to the contact address of the recipient comprises:
detecting a type of the contact address input by the user;
generating and sending a first type of electronic information if the contact address is detected to be of a first type; and
generating and sending a second type of electronic information if the contact address is detected to be of a second type,
wherein the first type of the contact address is an email address and the first type of electronic information is email, and wherein the second type of the contact address is mobile phone number and the second type of electronic information is text message.

6. A method for receiving interactive information on the Internet, comprising:
receiving, at a user device, electronic information sent to a contact address of a user and displaying at the user device the received electronic information, the received electronic information comprising content of the interactive information and a uniform resource locator (URL) address that contains a passcode as a unique identifier of the user; and
sending, by the user device after detecting a click on the URL address, a response of the interactive information from the contact address of the user to a server, content of the response of the interactive information comprising the passcode of the user.

7. The method of claim 6, wherein the content of the response comprises at least one of a selected voting item, a log reply and an album comment.

8. A method for updating interactive information on the Internet, comprising:
prompting, by a first user device, a first user to input a contact address of a second user, after detecting a predetermined type of operation by the first user;
sending, by the first user device, electronic information to the contact address of the second user, the electronic information comprising the interactive information and a uniform resource locator (URL) address that contains a passcode as a unique identifier of the second user;
receiving, at a second user device, the electronic information and displaying at the second user device the received electronic information;
sending, by the second user device and after detecting a click on the URL, a response of the interactive information from the contact address of the second user to a server, content of the response of the interactive information comprising the passcode of the second user; and
updating, by the server, the interactive information posted on a web site according to the response received.

9. The method of claim 8, wherein the interactive information comprises at least one of voting information, log information and album information; wherein the predetermined type of operation comprising at least one of initiating the interactive information, editing the interactive information, and entering a web page associated with the interactive information; and wherein the content of the response comprising at least one of a selected voting item, a log reply and an album comment.

10. The method of claim 8, further comprising: displaying, by the first user device, contact addresses of contact persons of the first user when prompting the first user to input the contact address of the second user; and wherein sending the electronic information to the contact address of the second user comprises detecting a type of the contact address input by the first user, generating a first type of electronic information if the contact address is detected to be of a first type, or generating a second type electronic information if the contact address is detected to be of a second type, wherein the first type of the contact address is an email address and the first type of electronic information is email, and wherein the second type of the contact address is mobile phone number and the second type of electronic information is text message.

11. A user device for sending interactive information on the Internet, comprising:
a prompting unit, configured to prompt user to input a contact address of a recipient of the interactive information after detecting a predetermined type of operation by the user; and
a transmission unit, configured to send electronic information to the contact address of the recipient, the electronic information comprising the interactive information and a uniform resource locator (URL) address that contains a passcode as a unique identifier of the recipient.

12. The user device of claim 11, wherein the interactive information comprises at least one of voting information, log information and album information.

13. The user device of claim 11, wherein the predetermined type of operation comprises at least one of: initiation of the interactive information, editing the interactive information, and entering a web page associated with the interactive information.

14. The user device of claim 11, wherein the user device further comprises a display unit for displaying contact addresses of contact persons of the user when prompting the user to input the contact address of the recipient.

15. The user device of claim 11, wherein sending the electronic information to the contact address of the recipient comprises:
detecting a type of the contact address input by the user;
generating a first type of electronic information if the contact address is detected to be of a first type; and
generating a second type of electronic information if the contact address is detected to be of a second type,
wherein the first type of the contact address is an email address and the first type of electronic information is an email, and wherein the second type of the contact address is mobile phone number and the second type of electronic information is text message.

16. A user device for receiving interactive information on the Internet, comprising:
a display unit, configured to receive and display electronic information sent to a contact address of a user, the electronic information comprising content of the interactive information and a uniform resource locator (URL) address that contains a passcode as a unique identifier of the user; and
a transmission unit, configured to send, after detecting a click on the URL address, a response of the interactive information from the contact address of the user to a server, content of the response of the interactive information comprising the passcode of the user.

17. The user device of claim 16, wherein the content of the response comprises at least one of: a selected voting item, log reply information and an album comment.

18. A system for updating interactive information on the Internet, comprising:
a first user device, configured to prompt a first user to input a contact address of a second user, after detecting a predetermined type of operation by the first user; and to send electronic information to the contact address of the second user, the electronic information comprising the interactive information and a uniform resource locator (URL) address that contains a passcode as a unique identifier of the second user;
a second user device, configured to receive and display the electronic information; and to send, after detecting a click on the URL address, a response of the interactive information from the contact address of the second user to a server, content of the response of the interactive information comprising the passcode of the second user; and
a server, configured to update the interactive information posted on a web site according to the response received.

19. The system of claim 18, wherein the interactive information comprises at least one of: voting information, log information and album information; wherein the predetermined type of operation comprises at least one of: initiation of the interactive information, editing the interactive information, and entering a web page associated with the interactive information; and wherein the content of the response comprises at least one of: a selected voting item, a log reply and an album comment.

20. The system of claim 18, wherein the first user device is further configured to display contact addresses of contact persons of the first user when prompting the first user to input the contact address of the second user; and wherein sending the electronic information to the contact address of the second user comprising detecting a type of the contact address input by the first user, generating a first type of electronic information if the contact address is detected to be of a first type, and generating a second type electronic information if the contact address is detected to be a second type, wherein the first type of the contact address is an email address and the first type of electronic information is an email, and wherein the second type of the contact address is mobile phone number and the second type of electronic information is text message.
